(19) United States
(12) Patent Application Publication
(10) Pub. No.: US 2010/0007491 A1
(43) Pub. Date: Jan. 14, 2010

(54) INTEGRATED IMAGE RECOGNITION AND SPECTRAL DETECTION DEVICE AND A DEVICE AND METHOD FOR AUTOMATICALLY CONTROLLING THE SETTINGS OF A LIGHT BY IMAGE RECOGNITION AND SPECTRAL DETECTION OF THE LIGHT

(75) Inventors: Richard P. Kleihorst, Kasterlee (BE); Eduard J. Meijer, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/373,819

(22) PCT Filed: Jul. 10, 2007
(86) PCT No.: PCT/IB07/52734

§ 371 Date: Jan. 14, 2009

(30) Foreign Application Priority Data
Jul. 28, 2006 (EP) 06118092.3

(51) Int. Cl. G08B 21/00; G01J 3/28

(52) U.S. Cl. 340/540; 356/454

(57) ABSTRACT

The invention relates to an integrated image recognition and spectral detection device particularly suitable for monitoring settings of a light. The invention also relates to automatically controlling the settings of a light by image recognition and spectral detection of the light, particularly to automatically controlling the color point of the light in response to the image recognition. The invention provides an integrated image recognition and spectral detection device (10) comprising an image sensor array (12) for recognizing images and motion, and a light filtering structure (14) for detecting spectral components of received light which covers at least a part of the light-sensitive surface of the image sensor array (12). The invention has the main advantage that it combines the recognizing of images and motion with detecting spectral components and, thus, allows to implement a sophisticated automatic control of the settings of a light.

The invention relates to an integrated image recognition and spectral detection device particularly suitable for monitoring settings of a light. The invention also relates to automatically controlling the settings of a light by image recognition and spectral detection of the light, particularly to automatically controlling the color point of the light in response to the image recognition and spectral detection.

Intuitive interaction in an ambient intelligence environment constitutes a user-friendly way of adjusting a system, such as a sound system, a movie channel or a lighting system. The changes due to such intuitive interaction need to be monitored in order to achieve the desired effect, for example dimming of an illumination, changing a spotlight, or increasing the sound volume. In case of lighting systems, several parameters may be monitored such as the intensity and color of a light. A typical example of intuitive interaction is the lighting in a shop window: as settings may change or objects may be placed at different spots, it may be necessary to adjust the light intensities and/or colors of light sources to maintain a certain lighting effect in the shop window.

Particularly in modern lighting systems, in which white light is generated by light emitting diodes (LEDs), for example with a red, green and blue (RGB) LED (or more and/or different colors of LEDs), a monitoring of the light color is important since the mixed light from the LEDs only results in white light if the light from each individual LED is properly combined with the light coming from the other LEDs. Such LED-based lighting is widely used in applications such as, for example, LCD back lighting, commercial-freezer lighting and white light illumination. Each lighting system, comprising independent RGB light sources for creating a mixed white light, presents difficult issues because the optical characteristics of the individual RGB light sources usually vary with temperature, electric supply, and aging. For example, LEDs show the following behavior with increasing temperatures: the light created by a typical LED has spectral shifts to longer wavelengths, the light intensity decreases, and a spectral broadening occurs. With an increase of the electric forward current of a typical LED, a spectral shift to shorter wavelengths occurs and the intensity increases. Furthermore, aging has the effect that the light intensity decreases, and a spectral change occurs. Also, LEDs show a batch-to-batch variation resulting in a peak wavelength spread and an intensity spread. In addition, the characteristics of the individual LEDs vary significantly from batch to batch for the same LED fabrication process and from manufacturer to manufacturer. Therefore, the quality of the light produced by LED-based illumination can vary significantly and the desired color and the required lighting level of the white light cannot be obtained without a suitable monitoring and feedback system.

It is an object of the present invention to provide a device suitable for monitoring settings of a light and giving a feedback for controlling the light, and a device and a method for automatically controlling the settings of a light, such as for example an RGB based LED light.

In order to achieve the object defined above, the invention provides an integrated image recognition and spectral detection device comprising

an image sensor array for recognizing images and motion, and
a light filtering structure, which covers at least a part of the light-sensitive surface of the image sensor array, for filtering spectral components of received light.

In order to achieve the object defined above, the invention further provides a device for automatically controlling the settings of a light by image recognition and spectral detection of the light, comprising
image sensing means being adapted for recognizing images and motion,
spectral detection means being adapted for detecting spectral components of received light, and
control means being adapted for automatically controlling a light emitted by a light source in response to recognized images and motions and spectral components.

In order to achieve the object defined above, the invention also provides a method for automatically controlling the settings of a light by image recognition and spectral detection of the light, wherein
image sensing means recognize images and motion,
spectral detection means detect spectral components of received light, and
control means automatically control a light emitted by a light source in response to recognized images and motions and spectral components

The characteristic features according to the invention provide the advantage that both movements of an object, for example for intuitive interaction, and spectral components of light may be detected. Thus, it is possible to increase the comfort of usage of a complex lighting system by allowing to intuitively interact with the system and to improve the monitoring of light settings by detecting and monitoring spectral components of the lighting system. Particularly, an integrated device according to the invention provides the advantage that it combines an image sensor array with a light filtering structure in a single device. This allows to electrically connect both components so that no separate connections between the components are required. Such an integrated device may be, for example, applied to efficiently control complex lighting systems, particularly RGB LED based lighting systems, while also an intuitive interaction by detecting movement of objects such as of users of a lighting system in space may be implemented. For example, specific movements, which may be used to indicate desired changes in light settings, can thus be detected through the image sensor array of the device, and the desired changes in light settings, i.e. in color and intensity may be monitored by the spectrometer part of the integrated device. The device and the method for automatically controlling the settings of a light by image recognition and spectral detection of the light provide the advantage that images and motions for an intuitive interaction, for example for changing light settings, may be recognized, and at the same time the change of the settings may be detected via detecting the spectral components giving an nearly immediate feedback about the settings change. This allows one to create a lighting system offering intuitive interaction and efficient monitoring of light settings.

It should be noted that the invention is not limited to LED lighting, it can be used for any kind of lighting, where it would be desirable to combine spectral detection with image recognition. This can also be an ambient intelligent area, where the mood (facial expression) or movement of the person in a room is reflected in an appropriate change of the light colors (which can also be e.g. fluorescent tubes) in that room.

According to an embodiment of the invention, the light filtering structure may be a Fabry-Perot resonator structure, which covers a part of the light-sensitive surface of the image sensor array, for detecting spectral components of received light.

According to a further embodiment of the invention, the light filtering structure may be an edge filter array, which covers a part of the light-sensitive surface of the image sensor array, for detecting spectral components of received light.

According to an embodiment of the invention, the edge filter array may be an array of cut filtered glass

According to an embodiment of the present invention, the Fabry-Perot resonator structure of the integrated device may comprise two semitransparent metallic layers and a dielectric layer sandwiched between the two semitransparent metallic layers. Thus, it is possible to implement the resonator structure with conventional semiconductor manufacturing methods such as evaporation of the metallic layers and deposition of the dielectric layer.

According to a further embodiment of the invention, one for the metallic layers may be deposited as first reflective and partly transparent layer on at least a part of the light-sensitive surface of the image sensor array, the dielectric layer may be subsequently deposited on the first reflective and partly transparent layer, and the other one of the metallic layers may be deposited as second reflective and partly transparent layer on the dielectric layer. The resonator structure may therefore be efficiently produced layer by layer.

According to a further embodiment of the present invention, the dielectric layer may comprise different thicknesses in order to allow filtering of different spectral components of received light. Therefore, it is possible to more precisely monitor settings of a light.

Particularly, the thickness may be graduated in steps, for example nearly equal steps, according to an embodiment of the present invention. Thus, the resonator structure may be prepared to filter specific components of received lights, for example characteristic spectral components of a light source.

In order to create the graduation in steps, the dielectric layer may be etched in different processing steps after deposition using conventional lithography according to a further embodiment of the present invention.

Furthermore, the Fabry-Perot resonator structure may comprise several segments of different thicknesses according to an embodiment of the present invention. For example, the Fabry-Perot resonator structure may be segmented to form a chessboard-like structure, wherein each rectangular segment corresponds to a region with nearly equal thickness of the dielectric layer, i.e., adjusted for filtering a certain spectral component of incident light.

According to a further embodiment of the present invention, the image sensor array may be a charged coupled device (CCD), a photodiode array, or a CMOS gate array. It should be noted that an individual “pixel” of the Fabry-perot resonator (so an area with a single dielectric thickness) may cover a number of “pixels” of the image sensor array, to enhance the signal per filter signal.

According to an embodiment of the present invention, the control means of the device for controlling a light by image recognition and spectral detection of the light may be further adapted to process recognized images and motions in that the intensity and color of the light emitted by the light source is adjusted in accordance with the recognized images and motions and an algorithm for intuitive motion light control. For example, the control means may be implemented by a microprocessor or—controller and a memory storing the algorithm for intuitive motion light control.

According to an embodiment of the present invention, the control means may be further adapted to process the detected spectral components in that the color of the light emitted by the light source is adjusted in accordance with the detected spectral components and an algorithm for color adjustment. Also here, the control means may be implemented by a microprocessor or—controller and a memory storing the algorithm for color adjustment.

According to a further embodiment of the invention, the control means may be further adapted to process the light source position by determining the direction of the incident light by backtracking and image analysis of the recognized images. The determination of the direction of the light source is possible since the light source position is imaged by the image sensor array. The light source position or direction of incident light may be helpful since the Fabry-Perot resonator structure has an angular dependence: light hitting the Fabry-Perot at different angles results in a different spectral response of the filter. Thus it may be important for a correct detection of the spectral components of incident light to know where the light is coming from, which can be known from the image sensor array.

According to a yet further embodiment of the invention, the control means may be further adapted to correct the spectral components detected by the Fabry-Perot resonator structure in accordance with the determined direction of the incident light.

The image sensing means and the spectral detection means may be implemented by an integrated device according to the invention and as described above.

Furthermore, the control means may be also integrated into the integrated device according to an embodiment of the present invention.

According to a further embodiment of the invention, a computer program is provided, wherein the computer program may be enabled to carry out at least a part of the method according to the invention when executed by a computer. For example, the control means may be implemented by a computer program. In such case, a computer executing the computer program may receive signals from the image sensing means and from the spectral detection means, and may process the received signals in order to adjust the light settings corresponding to any interactions detected by the image sensing means and adjust the light settings corresponding to the spectral components detected by the spectral detection means.

According to an embodiment of the invention, a record carrier such as a CD-ROM, DVD, memory card, floppy disk or similar storage medium may be provided for storing a computer program according to the invention.

These and other aspects of the invention will be apparent from and elucidated with reference to the embodiment(s) described hereinafter.

The invention will be described in more detail hereinafter with reference to exemplary embodiments. However, the invention is not limited to these exemplary embodiments.

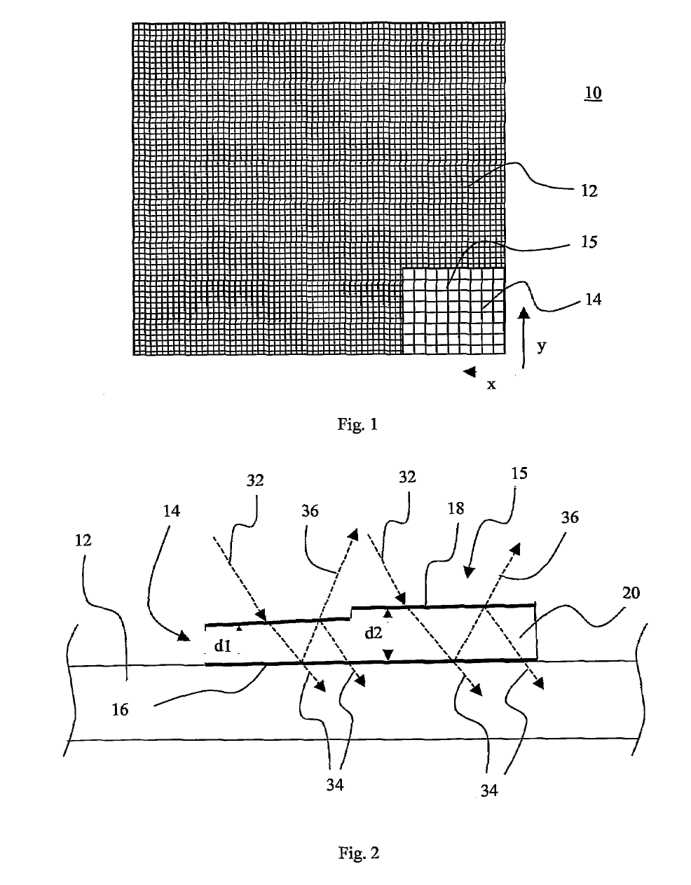

FIG. 1 shows an embodiment of an integrated image recognition and spectral detection device according to the invention;

FIG. 2 shows sectional view of a further embodiment of an integrated image sensor array and a spectral detector according to the invention; and

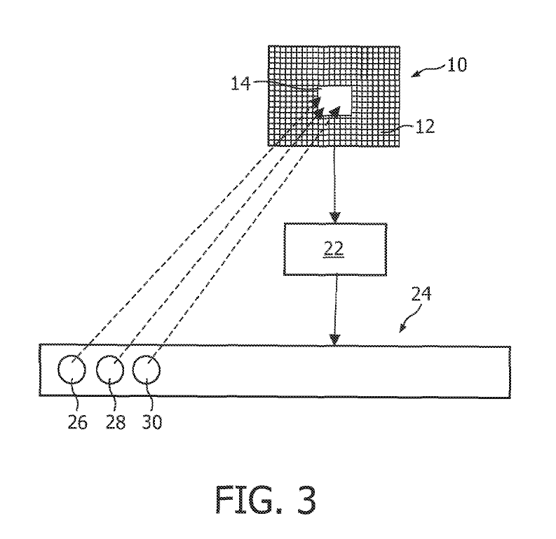

FIG. 3 shows a block diagram of an embodiment of a device for controlling a light by image recognition and spectral detection of the light according to the invention.

The integrated image recognition and spectral detection device 10, shown in FIG. 1, is a semiconductor device fabricated with conventional semiconductor manufacturing methods. It comprises an image sensor array 12 such as a CCD, photodiode array, or CMOS gate array, and a spectrometer 14 located on the light-sensitive surface of the image sensor array 12. The spectrometer 14, which covers only a part of the light-sensitive surface of the image sensor array 12, is implemented by a Fabry-Perot resonator structure as shown in a sectional view in FIG. 2. Thus, the spectrometer serves as a filter for light impinging on the part of the image sensor array 12, covered by the Fabry-Perot resonator structure 14. The covered part of the image sensor array serves for detecting certain spectral components of the impinging light.

The Fabry-Perot resonator structure is an optical interferometer where the incident light 32 suffers multiple reflections 34 and 36 between two coated surfaces. The Fabry-Perot resonator structure of FIG. 2 comprises two semitransparent metallic layers 16, 18 and a dielectric layer 20, for example SiO₂ etalon, sandwiched between the two semitransparent metallic layers 16 and 18. Thus, a cavity for light beams is defined between the two semitransparent metallic layers 16 and 18 in which light beams 34 and 36 may be reflected multiple times.

The Fabry-Perot resonator forms a narrow-band filter for the incident light. The thickness of the dielectric layer 20 defines the filtering function of the Fabry-Perot resonator structure 14. The emerging wave fronts of incident light beams 32 interfere constructively only if there is no phase difference between them. At other wavelengths, destructive interference of the transmitted wave fronts reduces the transmitted intensity toward to zero. Therefore, the Fabry-Perot resonator structure 14 acts as a filter that transmits certain wavelengths (light beams 34) and reflects the others (light beams 36) back to the light source. The impinging spectrum is filtered in the Fabry-Perot resonator structure and the intensity of the selected spectral component is measured in transmission using the underlying image sensor array 12.

The thickness of the dielectric layer 20, which is enclosed between the two semitransparent metallic layers, determines the wavelength tuned to. The reflectance of the metallic layers 16 and 18 determines the full-width-at-half-mean of the transmitted spectrum, and therewith the specificity with which the wavelength can be selected.

In order to filter several spectral components from the incident light, the Fabry-Perot resonator structure 14 may comprise regions of different thickness. In FIG. 2, the dielectric layer 20 is graduated in a step and, therefore, comprises two different thicknesses d1 and d2, thus defining two different wavelengths to which the resonator structure is tuned to. The graduation may be achieved by an etching technique with which parts of the dielectric layer 20 are etched back by a certain amount such that a graduated sectional structure may be achieved.

In order to tune the Fabry-Perot resonator structure to a plurality of wavelengths, a rectangular Fabry-Perot resonator structure as shown in FIG. 1 may be graduated in steps in two different directions, for example in a x- and y-direction, such that chessboard-like structure is formed. This chessboard-like structure comprises a plurality of rectangular regions 15 each corresponding to a region of the dielectric layer with a specific thickness d_{xy}. With such a segmentation of the Fabry-Perot resonator structure in regions 15 with different thicknesses, the resonator may be tuned to different wavelengths. The more fine the segmentation is selected, the more different wavelengths or spectral components, respectively, of the incident light may be detected.

The resonator structure of FIG. 2 may be produced by coating it on the image sensor array 12. This coating process can be done for example by depositing an initial reflective layer 16 (partly transparent, for example a layer of Al) on part of the sensor array 12 that is to become the spectral detector. The process of deposition may be performed by evaporation. Subsequently a dielectric layer 20, for example a layer of PECVD SiO2, is deposited that is etched in different etch steps using conventional lithography to end up with different dielectric thicknesses d1 and d2 and thus also different filter response. Finally for the finish of the filter array a second reflective (partly transparent) layer 18, for example a layer of Ag, is deposited on the dielectric layer 20 (again for example by evaporation).

In FIG. 3, an integrated device 10 similar to the one shown in FIG. 1 is used for automatically controlling the settings of a lighting system 24, such as a LED lighting array. The light bar 24 creates white light with RGB LEDs 26, 28 and 30. In order to exactly control the color of the created light, it is important to detect certain spectral components contained in the created light. The integrated device 10 receives the light created by the RGB LEDs 26, 28, and 30 and determines with a Fabry-Perot resonator structure 14 coated in the middle of the light-sensitive surface of an image sensor array 12 of the device 10 certain spectral components, for example the R, G, and B components.

The detected spectral components are transmitted from the device 10 to control means 22 for processing with a color setting control algorithm. The control algorithm is adapted to control the RGB LEDs 26, 28, and 30 such that the desired color point is obtained. The image sensor array serves to recognize images and motion, for example user interactions for adjusting settings of the lighting system 24.

A typical application is the intuitive interactive control of the light intensity. When a user desires to increase the light intensity, she/he may lift an arm in front of the device 10. The image sensor array 12, for example a CCD, recognizes the motion of the arm and transmits respective signals to the control means 22. An algorithm adapted for interactive light setting control processes the received signals and increases the light intensity by increasing the electric forward current for the RGB LEDs 26, 28, and 30. At the same time, the part of the image sensor array 12, which is covered by the Fabry-Perot resonator structure 14, continuously detects the spectral components contained in the incident light and transmits corresponding signals to the control means 22. The color setting control algorithm processes the detected spectral components and adjust the electric current for the LEDs 26, 28 and 30 separately based on the detected spectral components, in order to achieve the desired color point also at the increased light intensity. Naturally, further control algorithms for processing the signals received from the device 10 may be implemented in order to automatically control further parameters of the created light.

The invention is particularly suitable for application in the field of ambient intelligence, particularly in intuitive lighting control, light management, color point control and feedback correction for color drifting, for example of RGB LED lighting.

The invention has the main advantage that it combines the recognizing of images and motion with detecting spectral components and, thus, allows to implement a sophisticated automatic control of the settings of a light.

At least some of the functionality of the invention such as functionality of the control means may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. An integrated image recognition and spectral detection device comprising:
an image sensor array for recognizing images and motion, the image sensor array having a light-sensitive surface, and
a light filtering structure, which covers at least a part of the light-sensitive surface, for detecting spectral components of received light.

2. The integrated device of claim 1, wherein the light filtering structure is a Fabry-Perot resonator structure, which covers a part of the light-sensitive surface of the image sensor array.

3-4. (canceled)

5. The integrated device of claim 2, wherein the Fabry-Perot resonator structure comprises two semitransparent metallic layers and a dielectric layer sandwiched between the two semitransparent metallic layers.

6. The integrated device of claim 5, wherein one for the metallic layers is deposited as first reflective and partly transparent layer on at least a part of the light-sensitive surface of the image sensor array, the dielectric layer is subsequently deposited on the first reflective and partly transparent layer, and the other one of the metallic layers is deposited as second reflective and partly transparent layer on the dielectric layer.

7. The integrated device of claim 5, wherein the dielectric layer has a variable thickness in order to filter different spectral components of received light.

8-11. (canceled)

12. A device for automatically controlling the settings of a light by image recognition and spectral detection of the light, comprising
image sensing means being adapted for recognizing images and motion,
spectral detection means being adapted for detecting spectral components of received light, and
control means being adapted for automatically controlling a light emitted by a light source in response to recognized images and motions and spectral components.

13. The device of claim 12, wherein the control means are further adapted to process recognized images and motions in that the intensity and color of the light emitted by the light source is adjusted in accordance with the recognized images and motions and an algorithm for intuitive motion light control.

14. The device of claim 12, wherein the control means are further adapted to process the detected spectral components in that the color of the light emitted by the light source is adjusted in accordance with the detected spectral components and an algorithm for color adjustment.

15. The device of claim 12, wherein the control means are further adapted to process the light source position by determining the direction of the incident light by backtracking and image analysis of the recognized images.

16. The device of claim 15, wherein the control means are further adapted to correct the spectral components detected by the Fabry-Perot resonator structure in accordance with the determined direction of the incident light.

17. The device of claim 12, wherein the image sensing means and the spectral detection means comprise an integrated image recognition and spectral detection device comprising:
an image sensor array for recognizing images and motion, the image sensor array having a light-sensitive surface, and
a light filtering structure covering at least a part of the light-sensitive surface for detecting spectral components of received light.

18-21. (canceled)

22. The device of claim 17, wherein the light filtering structure is a Fabry-Perot resonator structure covering a part of the light-sensitive surface of the image sensor array.

23. The device of claim 22, wherein the Fabry-Perot resonator structure comprises two semitransparent metallic layers and a dielectric layer sandwiched between the two semitransparent metallic layers.

24. The device of claim 23, wherein the dielectric layer has a variable thickness for filtering different spectral components of received light.

25. The device of claim 22, wherein the Fabry-Perot resonator structure comprises several segments of different thicknesses.

26. The device of claim 17, wherein the light filtering structure is an edge filter array covering a part of the light-sensitive surface of the image sensor array.

27. The device of claim 26, wherein the edge filter array is an array of cut filtered glass.

28. The device of claim 17, wherein the image sensor array is a charged coupled device, a photodiode array, or a CMOS gate array.
